(19) United States
(12) Patent Application Publication
(10) Pub. No.: US 2026/0217124 A1
(43) Pub. Date: Jul. 30, 2026

(54) VEHICLE CONTROL APPARATUS

(71) Applicant: TOYOTA JIDOSHA KABUSHIKI KAISHA, Toyota-shi (JP)

(72) Inventors: Ryosuke TANIMURA, Nagoya-shi (JP); Aika Miyajima, Nagoya-shi (JP); Akari Yamada, Nagoya-shi (JP); Reina Yamamura, Nagoya-shi (JP)

(73) Assignee: TOYOTA JIDOSHA KABUSHIKI KAISHA, Toyota-shi (JP)

(21) Appl. No.: 19/455,972

(22) Filed: Jan. 22, 2026

(30) Foreign Application Priority Data
Jan. 28, 2025 (JP) 2025-012421

(51) Int. Cl. B60K 35/81; B60K 35/26; B60R 25/04; G06Q 30/0251

(52) U.S. Cl. CPC B60K 35/81; B60K 35/265; B60R 25/04; G06Q 30/0265

(57) ABSTRACT

A vehicle control apparatus includes a processor. The processor is configured to output, when a first signal indicating that payment of a debt regarding a vehicle is not correctly performed is received, at least one of a reminder and an advertisement of encouraging payment regarding performance of the debt in response to reception of the first signal.

### CROSS-REFERENCE TO RELATED APPLICATION

This application claims priority to Japanese Patent Application No. 2025- 012421 filed on January 28, 2025. The disclosure of the above-identified application, including the specification, drawings, and claims, is incorporated by reference herein in its entirety.

### BACKGROUND

### Technical Field

The present disclosure relates to a vehicle control apparatus.

### Description of Related Art

An aspect of sales services of vehicles is based on a loan contract. A user who purchases a vehicle based on a loan contract is required to make regular monetary payments. Thus, Japanese Patent No. 7209748 (JP 7209748 B) discloses a technology of transmitting to a user terminal a report of a payment situation of a loan, regarding delay of the loan, or of making an encouragement to make the payment, and when the report is unsealed at the user terminal, restraining start of a motive power source of the vehicle.

### SUMMARY

However, since it is more desirable that payments be made than that the use of the vehicle be restrained, a creditor of a car lease or a car loan wants to facilitate smooth monetary payments by a debtor.

However, the technology disclosed in JP 7209748 B only gives the report of a payment situation of a loan, regarding delay of the loan, or of encouraging the payment thereof, is insufficient for encouraging a debtor to make payment regarding the debt, and there is room for improvement.

The present disclosure provides a vehicle control apparatus capable of encouraging a debtor to make payment regarding a debt.

A vehicle control apparatus according to the present disclosure includes a processor. The processor is configured to: perform, when a first signal indicating that completion of an unresolved condition regarding a target vehicle is not correctly performed is received from a account condition monitoring server configured to manage account condition of the target vehicle, control to lock engine start of the target vehicle in response to reception of the first signal; acquire at least one of an alert for prompting execution of the account condition or a publicity content for advancing execution of the account condition from a memory; reproduce and display at least one of an alert message corresponding to the alert and a visual content corresponding to the publicity content on a display apparatus included in the target vehicle ; and perform, after reproduction of the alert message or the visual content is finished, control to unlock engine start of the target vehicle.

A vehicle control apparatus according to the present disclosure includes a processor. The processor is configured to: perform, when a first signal indicating that payment of a debt regarding a target vehicle is not correctly performed is received from a credit management server configured to manage credit of the target vehicle, control to lock engine start of the target vehicle in response to reception of the first signal; acquire at least one of a reminder of encouraging payment regarding performance of the credit or an advertisement of encouraging payment regarding performance of the credit from a memory; reproduce and display at least one of a reminder message corresponding to the reminder and a video image corresponding to the advertisement on a display apparatus included in the target vehicle; and perform, after reproduction of the reminder message or the video image is finished, control to unlock engine start of the target vehicle.

A vehicle control apparatus according to the present disclosure includes a processor. The processor is configured to output, when a first signal indicating that payment of a debt regarding a target vehicle is not correctly performed is received, at least one of a reminder and an advertisement of encouraging payment regarding performance of the debt in response to reception of the first signal.

According to the present disclosure, an effect of being able to encourage a debtor to perform payment regarding a debt is attained.

In the aforementioned vehicle control apparatus, the outputting at least one of the reminder and the advertisement may include outputting at least one of a display and a voice regarding the at least one of the reminder and the advertisement.

In the aforementioned vehicle control apparatus, the outputting the reminder may include outputting a video image of encouraging payment regarding performance of the debt. The processor may be configured to: perform control to lock engine start of the target vehicle in response to reception of the first signal; and perform control to unlock engine start of the target vehicle after the video image is output for a predetermined time.

In the aforementioned vehicle control apparatus, the outputting the advertisement may include outputting a video image regarding a predetermined advertisement. The processor may be configured to: perform control to lock engine start of the target vehicle in response to reception of the first signal; and perform control to unlock engine start of the target vehicle after the video image is output for a predetermined time.

In the aforementioned vehicle control apparatus, the processor may be configured to: determine whether or not a second signal indicating that the debt is performed is received from a credit management server; and output, when the second signal is determined to be not received, at least one of the reminder and the advertisement periodically or not periodically until the second signal is received.

In the aforementioned vehicle control apparatus, the outputting at least one of the reminder and the advertisement may include outputting at least one of the reminder and the advertisement to at least one of an interior monitor and an exterior monitor included in the target vehicle.

In the aforementioned vehicle control apparatus, the outputting at least one of the reminder and the advertisement to the exterior monitor may include outputting a content indicating that the debt is not correctly performed.

In the aforementioned vehicle control apparatus, the outputting the reminder may include outputting information having a video image superimposed, the information indicating that the debt is not correctly performed, the video image being displayed on a terminal apparatus on a side of a person on a video call or a video conference when the video call or the video conference is performed via a communication unit included in the target vehicle.

In the aforementioned vehicle control apparatus, the outputting the reminder may include providing guidance of a facility for performing the debt or providing guidance of a path passing through the facility, via a car navigation system included in the target vehicle.

In the aforementioned vehicle control apparatus, the processor may be configured to: output, when the first signal is received, a lock signal for locking engine start of the target vehicle by remote control to an immobilizer included in the target vehicle to perform remote lock control; acquire at least one of a reminder of encouraging payment regarding performance of the debt or an advertisement of encouraging payment regarding performance of the debt from a memory; output at least one of a reminder message corresponding to the reminder and a video image corresponding to the advertisement to a display apparatus included in the target vehicle to display at least one of the reminder message and the video image by remote control; and output, after reproduction of the reminder message or the video image is finished, an unlock signal for unlocking engine start of the target vehicle by remote control to the immobilizer to perform remote unlock control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a vehicle control system according to Embodiment 1 of the present disclosure;

FIG. 2 is a sequence chart showing an example of exchange of information between a debt collection server, a credit management server, a vehicle information server, and a vehicle according to Embodiment 1 of the present disclosure;

FIG. 3 is a flowchart showing an outline of processing performed by the debt collection server according to Embodiment 1 of the present disclosure;

FIG. 4 is a flowchart showing an outline of processing performed by the vehicle information server according to Embodiment 1 of the present disclosure;

FIG. 5 is a flowchart showing an outline of processing performed by the vehicle according to Embodiment 1 of the present disclosure;

FIG. 6 is a flowchart showing an outline of processing performed by the vehicle according to a modification of Embodiment 1 of the present disclosure; and

FIG. 7 is a flowchart showing an outline of processing performed by the debt collection server according to Embodiment 2 of the present disclosure.

### DETAILED DESCRIPTION OF EMBODIMENTS

Hereafter, a vehicle control apparatus according to an embodiment of the present disclosure will be described with reference to the drawings. Notably, constituents in embodiments below include ones that can be readily substituted by a person skilled in the art or ones that are substantially identical.

### Embodiment 1

### Vehicle Control System

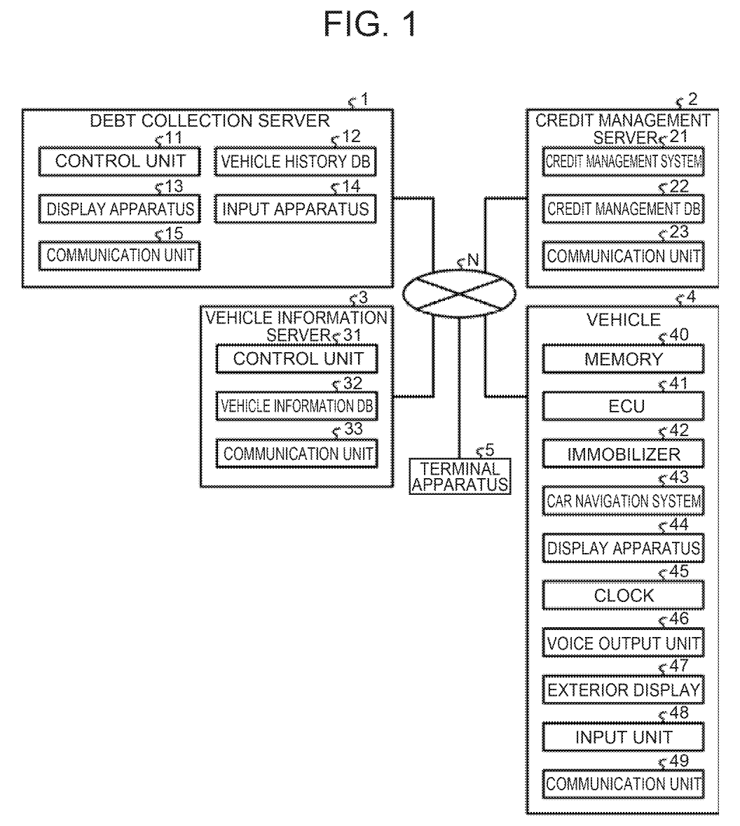

FIG. 1 is a block diagram showing a schematic configuration of a vehicle control system according to Embodiment 1. A vehicle control system 100 shown in FIG. 1 includes a debt collection server 1, a credit management server (account condition monitoring server) 2, a vehicle information server 3, a vehicle 4, and a terminal apparatus 5. All of the debt collection server 1, the credit management server 2, the vehicle information server 3, the vehicle 4, and the terminal apparatus 5 have communication functions, and are configured to communicate with one another via a network N to transmit and receive various kinds of information. The network N is constituted, for example, of an Internet network and a public network, such as a mobile phone network.

Moreover, in Embodiment 1, examples of "credit (account condition)" include credit regarding an installment contract in vehicle purchase, credit regarding a lease contract of the vehicle 4, credit regarding a subscription contract of the vehicle 4, and credit regarding a rental car contract of the vehicle 4.

Moreover, an example of a creditor in Embodiment 1 is a holder (owner) of the vehicle 4. Specifically, examples of the creditor include a dealer that has sold the vehicle 4, a credit company, and a bank. Moreover, an example of a debtor in Embodiment 1 is a user of the vehicle 4. Specifically, examples of the debtor include a purchaser of the vehicle 4 and a contractor or a company of a lease contract or the like.

### Functional Configuration of Debt Collection Server

First, a functional configuration of the debt collection server 1 is described. The debt collection server 1 remotely controls operation of the vehicle 4 for collecting a debt regarding the vehicle 4. As shown in FIG. 1, the debt collection server 1 includes a control unit 11, a vehicle history database (DB) 12, a display apparatus 13, an input apparatus 14, and a communication unit 15.

The control unit 11 is implemented, for example, by a processor constituted of a central processing unit (CPU) and the like, and a memory (main storage) constituted of a random access memory (RAM), a read-only memory (ROM), and the like.

The vehicle history DB 12 is a database that is constituted using a hard disk drive (HDD), a solid state drive (SSD), or the like and accumulates various kinds of information regarding the vehicle 4. The vehicle history DB 12 acquires and accumulates, for example, use situation information from the vehicle information server 3 in association with a vehicle identification number (VIN number) or the like. Moreover, the vehicle history DB 12 accumulates regular vehicle stop position information that is created based on positional information periodically transmitted from the vehicle 4 and is, for example, information regarding positions where the vehicle 4 is regularly or daily stopped and parked.

The display apparatus 13 is implemented, for example, by a liquid crystal display (LCD), an organic EL display (OLED), or the like. The display apparatus 13 displays various kinds of information under the control of the control unit 11.

The input apparatus 14 is implemented, for example, by a touch panel, a keyboard, a pointing device, and/or the like. The input apparatus 14 accepts input of various manipulations by a user, and outputs signals in accordance with the accepted manipulations to the control unit 11.

The communication unit 15 is constituted, for example, of a local area network (LAN) interface board, a wireless communication circuit for wireless communication, and/or the like. Under the control of the control unit 11 by way of example, the communication unit 15 transmits and receives information to/from the credit management server 2 and the vehicle information server 3 by means of communication via the network N.

### Functional Configuration of Credit Management Server

Next, a functional configuration of the credit management server 2 is described. The credit management server 2 is for managing credit regarding the vehicle 4. The credit management server 2 includes a credit management system 21, a credit management DB 22, and a communication unit 23.

When there is, among a plurality of vehicles 4 managed by the credit management DB 22, a vehicle 4 (target vehicle) that satisfies a requirement for engine start lock, the credit management system 21 transmits information for specifying the relevant vehicle 4 (for example, the vehicle identification number (VIN number) or the like) to the debt collection server 1. Here, the vehicle 4 (target vehicle) that satisfies the engine start lock requirement is any of a vehicle 4 (target vehicle) for which delay of payment or the like in credit by a debtor occurs, a vehicle 4 (target vehicle) for which payment of a debt (completion of an unresolved condition) is not correctly performed, and a vehicle 4 for which default on a debt or delay of performance of a debt occurs.

The credit management DB 22 associates and manages information for specifying each vehicle 4 with information regarding credit of the relevant vehicle 4. Here, an example of the information for specifying each vehicle 4 is the vehicle identification number (VIN number) or the like. Moreover, an example of the information regarding credit of the relevant vehicle 4 is payback information indicating a situation of payment of loan credit, lease credit, or the like.

The communication unit 23 is constituted, for example, of a LAN interface board, a wireless communication circuit for wireless communication, and/or the like. For example, the communication unit 23 transmits and receives information to/from the debt collection server 1 by means of communication via the network N.

### Functional Configuration of Vehicle Information Server

Next, a functional configuration of the vehicle information server 3 is described. The vehicle information server 3 acquires use situation information from the vehicle 4 in accordance with a request from the debt collection server 1, and transmits the acquired use situation information to the debt collection server 1. The vehicle information server 3 includes a control unit 31, a vehicle information DB 32, and a communication unit 33.

The control unit 31 is implemented, for example, by a processor constituted of a CPU and the like, and a memory (main storage) constituted of a RAM, a ROM, and the like. The control unit 31 acquires the use situation information from the vehicle 4 in accordance with the request from the debt collection server 1, and transmits the acquired use situation information to the debt collection server 1.

The vehicle information DB 32 accumulates the use situation information acquired from the vehicle 4 (target vehicle) and the information for specifying the vehicle 4 (for example, the vehicle identification number (VIN number) or the like) in association with each other. Under the control of the control unit 31, the vehicle information DB 32 transmits the use situation information to the debt collection server 1 in accordance with the request from the debt collection server 1.

The communication unit 33 is constituted, for example, of a LAN interface board, a wireless communication circuit for wireless communication, and/or the like. The communication unit 33 transmits and receives information to/from the debt collection server 1, the credit management server 2, and the vehicle 4, for example, by means of communication via the network N.

### Functional Configuration of Vehicle

Next, a functional configuration of the vehicle 4 is described. Examples of the vehicle 4 include a general engine vehicle (conventional vehicle: CONV), a hybrid electric vehicle (HEV), and a plug-in hybrid electric vehicle (PHEV). Otherwise, examples of the vehicle 4 may include a fuel cell electric vehicle (FCEV), and a battery electric vehicle (BEV).

The vehicle 4 includes a memory 40, an ECU 41, an immobilizer 42, a car navigation system 43, a display apparatus 44, a clock 45, a voice output unit 46, an exterior display 47, an input unit 48, and communication unit 49.

The memory 40 records various kinds of information regarding the vehicle 4, a program executed by the ECU 41, and two-dimensional (2D) map information or three- dimensional (3D) map information used by the car navigation system 43. Moreover, the memory 40 is constituted using a HDD, a SSD, or the like.

The ECU 41 is an electronic control unit, for example, having as a main constituent a microcomputer constituted of a CPU, a ROM, a RAM, and the like. When the vehicle 4 satisfies a predefined requirement for engine start lock (hereafter referred to as "engine start lock requirement"), the ECU 41 receives predetermined information from the vehicle information server 3, and based on these pieces of information, determines whether or not to activate engine start lock. When determining to activate the engine start lock, the ECU 41 locks engine start of the vehicle 4 (performs control not to start the engine thereof).

Examples of the "engine start lock requirement" include a case where the debtor of the vehicle 4 falls into default of a debt (for example, delay of payment thereof). Determination whether or not this engine start lock requirement is satisfied is performed, for example, by the credit management server 2. Then, when there is a vehicle 4 (target vehicle) that satisfies the engine start lock requirement, information for specifying the relevant vehicle 4 (for example, the vehicle identification number (VIN number) or the like) is transmitted from the credit management server 2 to the vehicle 4 via the debt collection server 1 and vehicle information server 3. For example, the target vehicle is the vehicle 4 that is subject to the credit.

Moreover, when receiving a second signal indicating, for example, that the debt of the vehicle 4 is performed on the vehicle 4 the engine start of which is locked, the ECU 41 unlock engine start of the vehicle 4.

Moreover, when receiving a first signal indicating that payment of the debt regarding the vehicle 4 (target vehicle) is not correctly performed (hereinafter simply referred to as "first signal") from the vehicle information server 3, the ECU 41 acquires at least one of a reminder regarding performance of the credit or an advertisement corresponding to performance of the debt from the memory 40, and reproduces and displays at least one of the reminder and the advertisement on the display apparatus 44. Specifically, when receiving the first signal, the ECU 41 controls the immobilizer 42 to lock engine start, and after reproducing and displaying at least one of the reminder and the advertisement on the display apparatus 44, controls the immobilizer 42 to unlock engine start. Furthermore, until receiving a second signal indicating that the debt regarding the vehicle 4 (target vehicle) is performed (hereinafter simply referred to as "second signal") from the vehicle information server 3, after finishing the reproduction of at least one of the reminder and the advertisement on the display apparatus 44, the ECU 41 periodically or not periodically reproduces and displays at least one of the reminder and the advertisement on the display apparatus 44. Here, being periodical means being for every predetermined time, for example, for every five minutes or being for every predetermined distance at which the vehicle 4 has traveled, for example, for every five kilometers. Notably, in Embodiment 1, the ECU 41 functions as a vehicle control apparatus. Moreover, information regarding the reminder regarding performance of the credit and the advertisement corresponding to performance of the debt stored in the memory 40 may be, for example, beforehand downloaded from the debt collection server 1 or the like, or may be received together with the first signal or subsequently to the first signal.

Based on the control of the ECU 41, the immobilizer 42 activates engine start lock or unlocks engine start. The immobilizer 42 is implemented by a processor constituted of a CPU and the like, and a memory (main storage) constituted of a RAM, a ROM, and the like, records key information (ID code) for unlocking engine start in the memory.

The car navigation system 43 receives, for example, electric waves from global positioning system (GPS) satellites to detect a current position of the vehicle 4. Notably, not being limited to a method using GPS satellites, examples of a utilized detection method of the current position of the vehicle 4 may include a method having light detection and ranging or laser image detection and ranging (LiDAR) combined with the 2D or 3D map information recorded in the memory 40.

The display apparatus 44 is implemented, for example, by a liquid crystal display (LCD), an organic EL display (OLED), or the like, is provided in a vehicle cabin inside the vehicle 4, and functions as an interior display. The display apparatus 44 displays various kinds of information under the control of the ECU 41.

The clock 45 is constituted using a timer having a clocking function, and the like, clocks time, and outputs the clocking results to the ECU 41.

The voice output unit 46 is constituted using a loudspeaker, a D/A converter circuit, an amplifier, and the like, and outputs various kinds of information under the control of the ECU 41. The voice output unit 46 converts and outputs digital voice data, for example, input from the ECU 41 into a voice to the outside.

The exterior display 47 is implemented, for example, by a liquid crystal display (LCD), an organic EL display (OLED), or the like, and is provided at a predetermined position outside the vehicle 4. Here, the predetermined position is provided in a rear window or a door on the exterior of the vehicle 4.

The input unit 48 is implemented, for example, by a touch panel, a keyboard, a pointing device, and/or the like. The input unit 48 accepts input of various manipulations by a user, and outputs signals in accordance with the accepted manipulations to the ECU 41.

The communication unit 49 is constituted, for example, of a data communication module (DCM) and the like. The communication unit 49 transmits and receives information to/from the vehicle information server 3 by means of communication via the network N.

### Terminal Apparatus

Next, the terminal apparatus 5 will be described. An example of the terminal apparatus 5 is an information processing terminal, such as a mobile phone. The terminal apparatus 5 accepts input of various manipulations by the debtor. Moreover, when engine start is locked by the immobilizer 42 of the vehicle 4, for example, the terminal apparatus 5 displays at least one of the reminder and the advertisement of encouraging payment regarding performance (a publicity content for advancing execution) of the debt for unlocking engine start of the vehicle 4, the at least one of the reminder and the advertisement being transmitted from the vehicle 4.

### Exchange of Information Between Apparatuses of Vehicle Control System

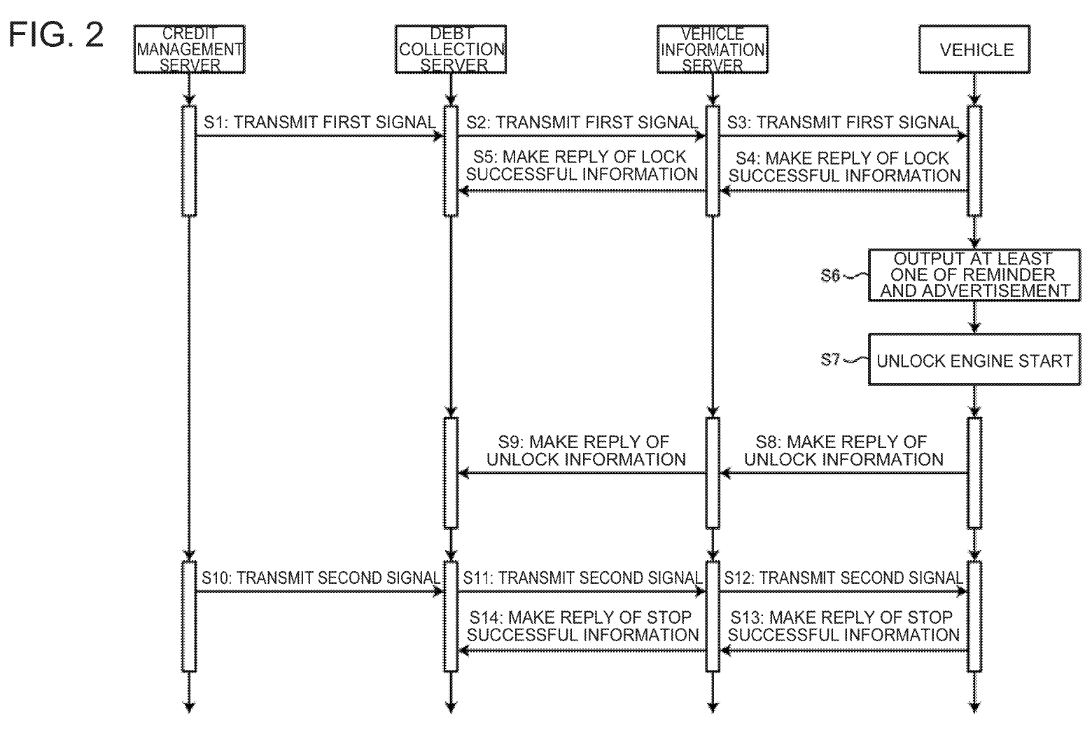

Next, exchange of information between the debt collection server 1, the credit management server 2, the vehicle information server 3, and the vehicle 4 is described. FIG. 2 is a sequence chart showing an example of exchange of information between the debt collection server 1, the credit management server 2, the vehicle information server 3, and the vehicle 4. Note that the case described hereinafter is an example in which the following processing is performed on the vehicle 4 (target vehicle) that is used by the debtor for whom delay of payment of the debt occurs, among the vehicles 4.

As shown in FIG. 2, first, when receiving the first signal indicating that payment of the debt is not correctly performed from the credit management server 2, for example (step Sl), the control unit 11 of the debt collection server 1 transmits this first signal to the vehicle information server 3 (step S2). Subsequently, the vehicle information server 3 transmits the first signal received from the debt collection server 1 to the vehicle 4 (step S3). Upon this, the vehicle 4 locks engine start, and makes a reply of successful information of activating engine start lock to the vehicle information server 3 (step S4). In this case, even in the case of an instruction of engine start via the input unit 48, the ECU 41 does not drive the engine of the vehicle 4. After that, the vehicle information server 3 transmits the reply of successful information of activating engine start lock, the reply being received from the vehicle 4, to the debt collection server 1 (step S5). In this case, the debt collection server 1 accumulates the successful information of activating engine start lock of the vehicle 4, the successful information being received from the vehicle information server 3, and the vehicle identification number (VIN number) of the vehicle 4 in association with each other, in the vehicle history DB 12.

Next, when the user (debtor) uses the vehicle 4 after engine start is locked, the vehicle 4 outputs at least one of the reminder and the advertisement regarding performance of the debt (step S6). In this case, in response to the first signal, the ECU 41 acquires the reminder of encouraging payment regarding performance of the credit (reminder information) (an alert for prompting execution of the account condition), the advertisement of encouraging payment corresponding to performance of the debt (moving picture data), and/or an advertisement of merchandise of a recommended article (moving picture data) from the memory 40, and reproduces and displays at least one of a reminder message corresponding to the reminder (an alert message corresponding to the alert) and video images (moving pictures) corresponding to the advertisements (visual contents corresponding to the publicity contents) on the display apparatus 44. In this stage, even in the case of an instruction of engine start via the input unit 48, the ECU 41 does not drive the engine of the vehicle 4. After that, after the reproduction of the reminder message or the video image on the display apparatus 44 is finished, the ECU 41 performs control to unlock engine start of the vehicle 4 (step S7). Thereby, the creditor can encourage the user (debtor) to make payment corresponding to performance of the debt. Furthermore, the user (debtor) confirms the reminder message or the video image of the advertisement, and afterward can use the vehicle 4. Notably, the ECU 41 not only displays and outputs the reminder message and the video image on the display apparatus 44 but also may cause the voice output unit 46 to output the reminder message and the advertisement as a voice.

Subsequently, the ECU 41 transmits a reply of unlock information indicating that engine start is unlocked to the vehicle information server 3 (step S8). Subsequently, the vehicle information server 3 transmits the reply of unlock information received from the vehicle 4 to the debt collection server 1 (step S9). In this case, the debt collection server 1 accumulates the unlock information indicating that engine start of the vehicle 4 is unlocked, the unlock information being received from the vehicle information server 3, and the vehicle identification number (VIN number) of the vehicle 4 in association with each other, in the vehicle history DB 12.

Next, when receiving the second signal indicating that the debt of the vehicle 4 is performed from the credit management server 2, for example (step S10), the control unit 11 of the debt collection server 1 transmits this second signal to the vehicle information server 3 (step S11). Subsequently, the vehicle information server 3 transmits the second signal received from the debt collection server 1 to the vehicle 4 (step S12). Upon this, the ECU 41 stops reproducing and displaying the reminder message and/or the advertisement on the display apparatus 44 while the debtor uses the vehicle 4, and transmits a reply of stop successful information indicating that stop of the reminder and the advertisement is successful to the vehicle information server 3 (step S13). Thereby, the vehicle 4 enables the debtor to use the vehicle 4 in the state where the reminder or the advertisement is not displayed on the display apparatus 44. Subsequently, the vehicle information server 3 transmits the reply of stop successful information received from the vehicle 4 to the debt collection server 1 (step S14). In this case, the debt collection server 1 accumulates the stop successful information received from the vehicle information server 3 and the vehicle identification number (VIN number) of the vehicle 4 in association with each other, in the vehicle history DB 12.

### Processing in Debt Collection Server

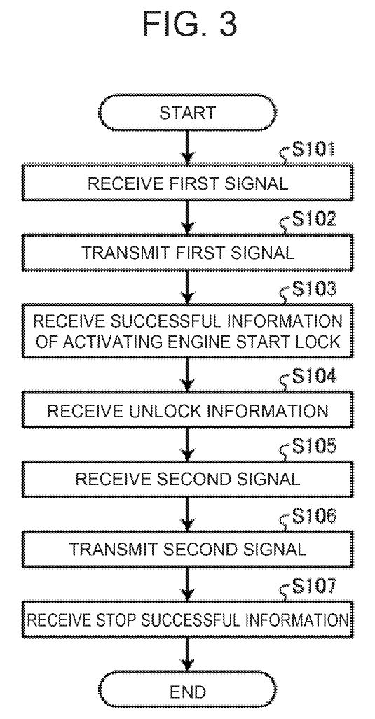

Next, processing performed by the debt collection server 1 is described. FIG. 3 is a flowchart showing an outline of processing performed by the debt collection server 1.

As shown in FIG. 3, when receiving the first signal indicating that payment of the debt is not correctly performed from the credit management server 2, for example (step S101), the control unit 11 transmits the first signal from the credit management server 2 to the vehicle information server 3 (step S102).

Subsequently, the control unit 11 receives the successful information of activating engine start lock of the vehicle 4 from the vehicle information server 3 (step S103).

Subsequently, the control unit 11 receives the unlock information indicating that engine start of the vehicle 4 is unlocked from the vehicle information server 3 (S104).

Subsequently, when receiving the second signal indicating that the debt of the vehicle 4 is performed from the credit management server 2, for example (step S105), the control unit 11 transmits the second signal to the vehicle information server 3 (step S106), and receives, for example, the stop successful information indicating that stop of the reminder and the advertisement is successful from the vehicle information server 3 (S107). After step S107, the debt collection server 1 ends this processing.

### Processing of Vehicle Information Server

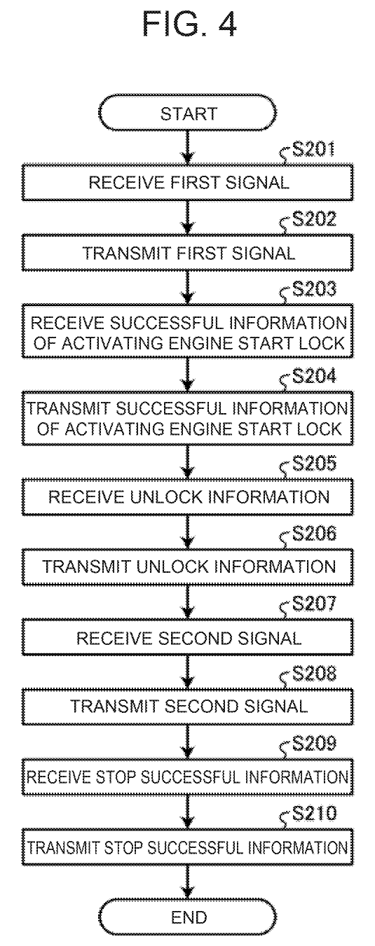

Next, an outline of processing performed by the vehicle information server 3 is described. FIG. 4 is a flowchart showing an outline of processing performed by the vehicle information server 3.

As shown in FIG. 4, first, the control unit 31 receives the first signal indicating that payment of the debt is not correctly performed from the debt collection server 1, for example (step S201), and transmits this received first signal to the vehicle 4 (step S202).

Subsequently, the control unit 31 receives the successful information of activating engine start lock of the vehicle 4 from the vehicle 4 (step S203), and transmits this received successful information to the debt collection server 1 (step S204).

Subsequently, the control unit 31 receives the unlock information indicating that engine start of the vehicle 4 is unlocked from the vehicle 4 (step S205), and transmits this received unlock information to the debt collection server 1 (step S206).

Subsequently, the control unit 31 receives the second signal indicating that the debt of the vehicle 4 is performed from the debt collection server 1, for example (step S207), and transmits this received second signal to the vehicle 4 (step S208).

Subsequently, the control unit 31 receives the stop successful information indicating that stop of the reminder and the advertisement is successful from the vehicle 4, for example (step S209), and transmits the received stop successful information to the debt collection server 1 (step S210). After step S210, the vehicle information server 3 ends this processing.

### Processing of Vehicle

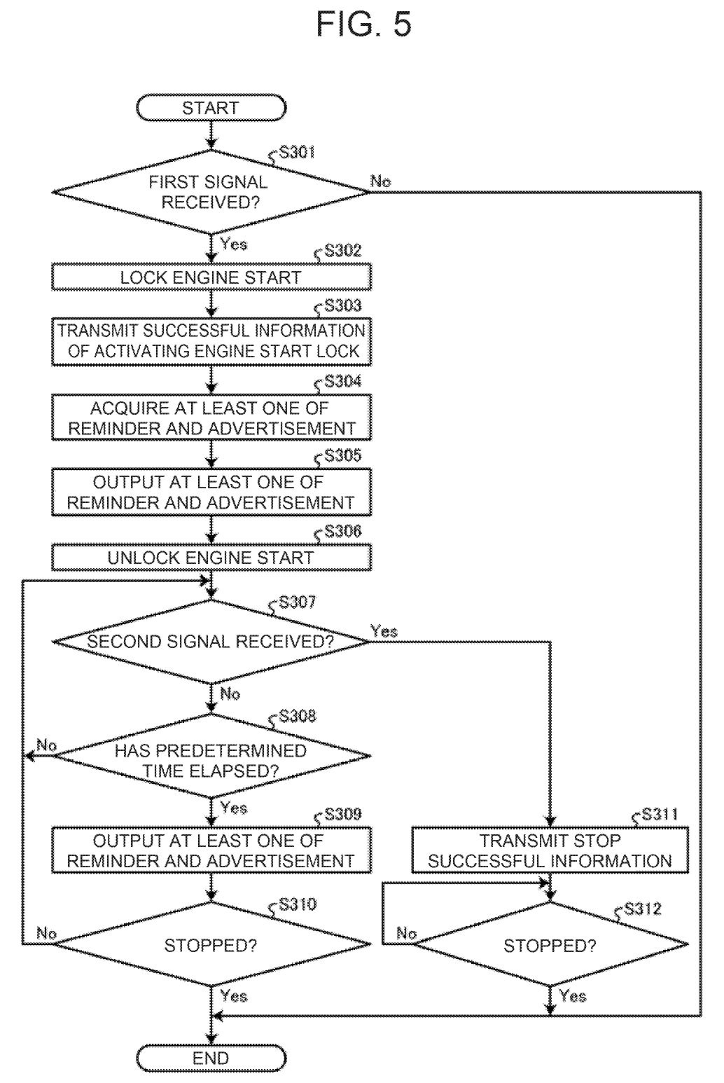

Next, an outline of processing performed by the vehicle 4 is described. FIG. 5 is a flowchart showing an outline of processing performed by the vehicle 4.

As shown in FIG. 5, first, when receiving the first signal indicating that payment of the debt has not been correctly performed from the vehicle information server 3, for example (step S301: Yes), the ECU 41 controls the immobilizer 42 to lock engine start (step S302), and transmits the successful information of activating engine start lock of the vehicle 4 to the vehicle information server 3 (step S303). In this case, even in the case of an instruction of engine start via the input unit 48, the ECU 41 does not drive the engine of the vehicle 4. Specifically, the ECU 41 sets a flag such that the immobilizer 42 does not react, for example, even when an engine start button of the input unit 48 is pressed. In this stage, the ECU 41 may display that engine start of the vehicle 4 is locked on the display apparatus 44, or may transmit and display this to/on the terminal apparatus 5 associated with the vehicle 4.

Subsequently, the ECU 41 acquires at least one of the reminder regarding performance of the debt or the advertisement corresponding to performance of the debt from the memory 40 (step S304), and reproduces, displays, and outputs at least one of the reminder and the advertisement on the display apparatus 44 (step S305). Specifically, the ECU 41 reproduces and displays at least one of the reminder message corresponding to the reminder, such as text of "Payment is delayed", and the video image (moving picture data) that corresponds to the advertisement of encouraging payment of the debt, the video image (moving picture data) being stored in a predetermined moving picture format, such as MP4, on the display apparatus 44.

Moreover, as in Aspect 1 to Aspect 4 below, the ECU 41 may output at least one of the reminder and the advertisement to at least one of the display apparatus 44 and the voice output unit 46.

### Aspect 1

The ECU 41 may cause the voice output unit 46 to reproduce and output at least one of the reminder and the advertisement. Thereby, the user can understand that payment of the debt is delayed.

### Aspect 2

Moreover, the ECU 41 may reproduce and display not only the advertisement regarding performance of the debt but also a video image, for example, for advertising predetermined merchandise and/or service on the display apparatus 44. Thereby, the creditor can encourage the user (debtor) to perform payment of the debt of the vehicle 4 and give the user sales promotion of desired merchandise and/or service. Moreover, the creditor can obtain advertising revenue.

### Aspect 3

Moreover, the ECU 41 may reproduce and display at least one of the reminder and the advertisement on at least one of the display apparatus 44 and the exterior display 47. For example, the ECU 41 may display as the reminder a reminder message "Payment is delayed" or the like on the exterior display 47. Since this allows persons in the area to know that payment of the debt regarding the vehicle 4 has not been correctly performed, the user can be further encouraged to make payment of the debt.

### Aspect 4

Moreover, the ECU 41 may provide guidance of a facility for performing the debt and/or provide guidance of a path passing through the facility for performing the debt, via the car navigation system 43 included in the vehicle 4. Specifically, via the car navigation system 43 based on the current position of the vehicle 4, the ECU 41 retrieves and displays a facility for performing the debt within a predetermined distance from the vehicle 4, for example, within five kilometers, such as a bank, a convenience store (ATM at the convenience store), and a supermarket, on the display apparatus 44. The ECU 41 of course may retrieve and display a path including a facility for performing the debt or a passable path that is close to the facility for performing the debt, the paths being on a path retrieved in accordance with a destination that the user inputs into the car navigation system 43 via the input unit 48, on the display apparatus 44. Thereby, the creditor can encourage the user (debtor) to make payment of the debt of the vehicle 4.

Subsequently, after at least one of the reminder and the advertisement is displayed for a predetermined time on the display apparatus 44, the ECU 41 controls the immobilizer 42 to unlock engine start (step S306). Specifically, the ECU 41 resets the flag such that the immobilizer 42 reacts, for example, when the engine start button of the vehicle 4 is pressed, thereby to unlock engine start. Thereby, in the case of an instruction of engine start via the input unit 48, the ECU 41 drives the engine of the vehicle 4. Consequently, the user confirms at least one of the reminder and the advertisement output on at least one of the display apparatus 44 and the voice output unit 46, and afterward can use the vehicle 4. That is, the creditor can more securely encourage the debtor, such as the user, to make payment of the debt.

Subsequently, when the second signal indicating that the debt of the vehicle 4 is performed is not received from the vehicle information server 3, for example (step S307: No), the ECU 41 determines whether or not a predetermined time, for example five minutes, has elapsed after reproduction of at least one of the reminder and the advertisement on the display apparatus 44 is performed and finished (step S308). When the ECU 41 determines that the predetermined time has elapsed (step S308: Yes), the vehicle 4 moves to step S309. On the other hand, when the ECU 41 determines that the predetermined time has not elapsed (step S308: No), the vehicle 4 returns to step S307.

Subsequently, the ECU 41 reproduces and displays at least one of the reminder message corresponding to the reminder information and the advertisement regarding advertisement information on the display apparatus 44 (step S309), and determines whether or not driving of the vehicle 4 has stopped (S310). Specifically, the ECU 41 determines whether or not the user stops the drive of the vehicle 4 by pressing the input unit 48 (power supply button). When the ECU 41 determines that the vehicle 4 stops the drive (step S310: Yes), the vehicle 4 ends the present processing. On the other hand, when the ECU 41 determines that driving of the vehicle 4 has not stopped (step S310: No), the vehicle 4 returns to step S307.

There is described the case where, in step S307, the second signal is received from the vehicle information server 3 (step S307: Yes). In this case, the ECU 41 stops reproducing and displaying at least one of the reminder and the advertisement on the display apparatus 44, and transmits, for example, the stop successful information indicating that stop of the reminder and the advertisement is successful to the vehicle information server 3 (step S311).

Subsequently, the ECU 41 determines whether or not the vehicle 4 stops the drive (step S312). When the ECU 41 determines that the vehicle 4 stops the drive (step S312: Yes), the vehicle 4 ends the present processing. On the other hand, when the ECU 41 determines that the vehicle 4 does not stop the drive (step S312: No), the vehicle 4 continues this determination until the vehicle 4 stops the drive.

There is described the case where, in step S301, the first signal is not received from the vehicle information server 3 (step S301: No). In this case, the vehicle 4 ends the present processing.

According to Embodiment 1 described above, when receiving the first signal, the ECU 41 acquires at least one of the reminder regarding performance of the credit or the advertisement corresponding to performance of the debt from the memory 40, and reproduces and displays at least one of the reminder and the advertisement thus acquired on the display apparatus 44, and hence, the debtor can be encouraged to make payment regarding the debt.

Moreover, according to Embodiment 1, when the ECU 41 receives the first signal, the ECU 41 outputs at least one of a display on the display apparatus 44 or a voice on the voice output unit 46, the display or the voice being relevant to at least one of the reminder regarding performance of the debt or the advertisement corresponding to performance of the debt, and hence, the debtor can understand that payment regarding the debt on the vehicle 4 is not correctly performed.

Moreover, according to Embodiment 1, since the ECU 41 reproduces and displays the video image of encouraging payment regarding performance of the credit on the display apparatus 44, the creditor can cause the debtor to understand that payment of the debt regarding the vehicle 4 is not correctly performed, that is, delay of performance of the debt, and to be encouraged to make payment regarding the debt.

Moreover, according to Embodiment 1, since the ECU 41 outputs at least one of a display on the display apparatus 44 or a voice on the voice output unit 46, the display or the voice being relevant to at least one of the reminder regarding performance of the credit or the advertisement corresponding to performance of the debt, the creditor can cause the debtor to understand that payment of the debt regarding the vehicle 4 is not correctly performed, and to be encouraged to make payment regarding the debt.

Moreover, according to Embodiment 1, since, after the ECU 41 displays at least one of the reminder and the advertisement for a predetermined time, the ECU 41 controls the immobilizer 42 to unlock engine start, the debtor can understand that the debtor does not perform payment regarding the debt on the vehicle 4, and afterward, can use the vehicle 4.

Moreover, according to Embodiment 1, since the ECU 41 outputs at least one of the reminder and the advertisement indicating that payment of the debt is not correctly performed, the creditor can cause the debtor to understand that payment regarding the debt on the vehicle 4 is not correctly performed, and to be encouraged to make payment of the debt.

### Modification of Embodiment 1

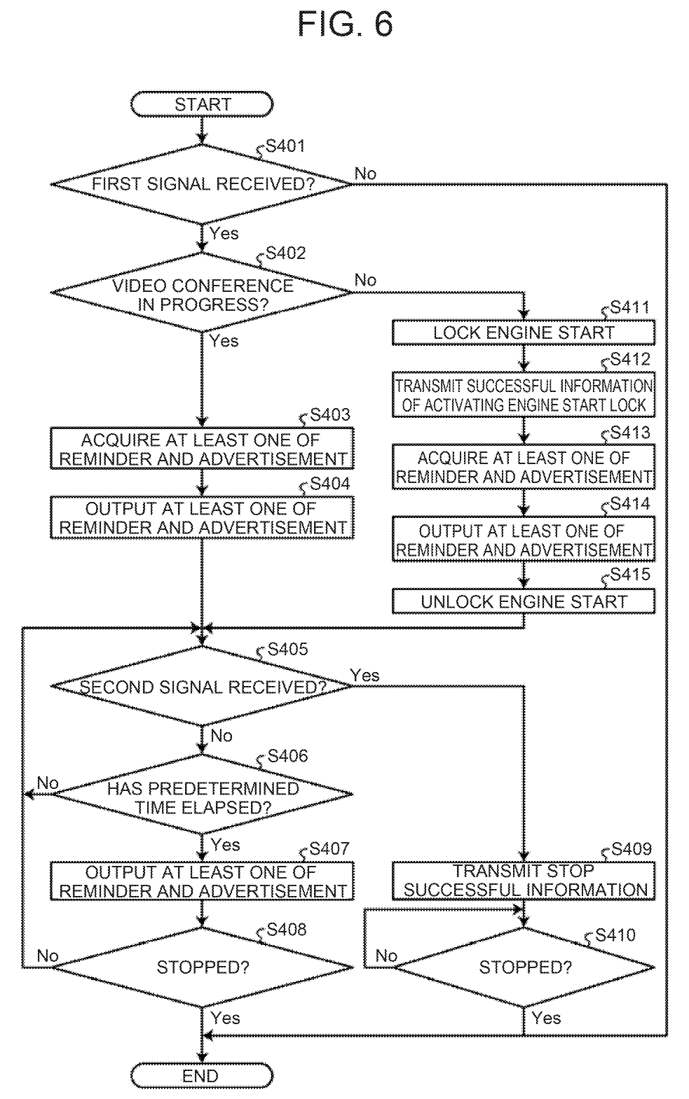

Next, a modification of Embodiment 1 will be described. FIG. 6 is a flowchart showing an outline of processing performed by the vehicle 4 according to a modification of Embodiment 1.

As shown in FIG. 6, first, when receiving the first signal indicating that payment of the debt has not been correctly performed from vehicle information server 3, for example (step S401: Yes), and when the user of the vehicle 4 is in the midst of a video conference to the outside using the communication unit 49 (step S402: Yes), the ECU 41 causes the vehicle 4 to move to step S403.

Subsequently, the ECU 41 acquires at least one of the reminder of encouraging payment regarding performance of the credit or the advertisement of encouraging payment regarding performance of the debt from the memory 40 (step S403), and combines and outputs at least one of the reminder message corresponding to the reminder and the video image corresponding to the advertisement with a video image corresponding to data transmitted by the communication unit 49 such that the at least one of the reminder message and the video image is displayed on a device of another person on a call of the video conference (web conference) that the user (debtor) of the vehicle 4 has joined (step S404). This causes the person on the call who joins the video conference with the user to know that the user of the vehicle 4 does not correctly perform payment of the debt regarding the vehicle 4. Not being limited to allowing it to be displayed on the device of the person on the call, the ECU 41 of course may combine and output at least one of the reminder message and the video image with the video image that is displayed on the terminal apparatus 5 that the user uses in the video conference via the communication unit 49. After step S404, the vehicle 4 moves to step S405. Step S405 to step S410 correspond to step S307 to step S312 in FIG. 5 mentioned above, respectively, step S411 to step S415 correspond to step S302 to step S306 in FIG. 5 mentioned above, respectively, and their detailed description is omitted.

According to the modification of Embodiment 1 described above, since another person on a call who joins a video conference with the user as the debtor results in knowing that the user of the vehicle 4 has not correctly performed payment of the debt regarding the vehicle 4, payment regarding the debt can be further encouraged.

### Embodiment 2

Hereinafter, Embodiment 2 is described. While in Embodiment 1, when the ECU 41 of the vehicle 4 receives the first signal, at least one of the reminder message corresponding to the reminder information and the advertisement regarding the advertisement information is reproduced and displayed on the display apparatus 44, in Embodiment 2, the control unit 11 of the debt collection server 1 performs the similar processing by remote control. Namely, in Embodiment 2, the control unit 11 functions as the vehicle control apparatus. Hereafter, processing performed by the debt collection server 1 according to Embodiment 2 is described.

### Processing of Debt Collection Server

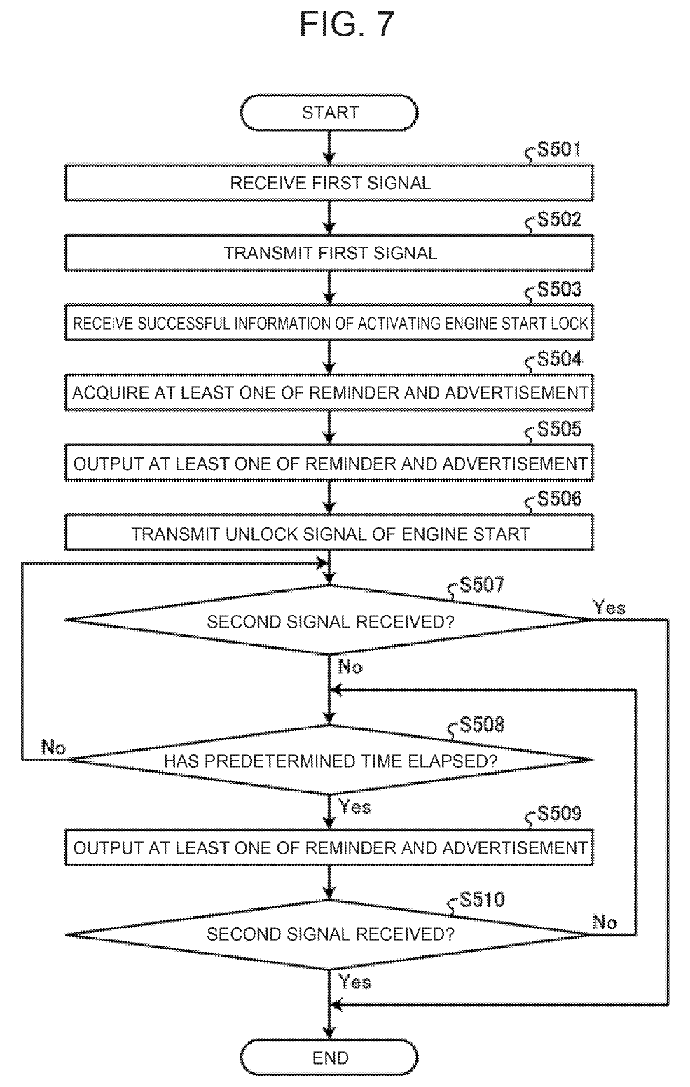

FIG. 7 is a flowchart showing an outline of processing performed by the debt collection server 1 according to Embodiment 2.

As shown in FIG. 7, when receiving the first signal indicating that payment of the debt is not correctly performed from the credit management server 2, for example (step S501), the control unit 11 transmits the first signal from the credit management server 2, and a lock signal for locking engine start of the vehicle 4 by remote control to the vehicle 4 via the vehicle information server 3 (step S502). In this case, the ECU 41 of the vehicle 4 controls the immobilizer 42 to lock engine start in response to the lock signal from the debt collection server 1. For example, the ECU 41 sets a flag such that the immobilizer 42 does not react even when the engine start button of the input unit 48 is pressed.

Subsequently, the control unit 11 receives the successful information of activating engine start lock of the vehicle 4 from the vehicle 4 via the vehicle information server 3 (step S503).

Subsequently, the control unit 11 acquires at least one of the reminder of encouraging payment regarding performance of the credit or the advertisement corresponding to performance of the debt from the memory 40 (step S504), and outputs at least one of the reminder and the advertisement such that at least one of the reminder and the advertisement is displayed on the display apparatus 44 of the vehicle 4 (step S505).

Subsequently, after outputting at least one of the reminder and the advertisement, the control unit 11 transmits an unlock signal for unlocking engine start of the vehicle 4 by remote control to the vehicle 4 via the communication unit 15 (step S506). In this case, the ECU 41 of the vehicle 4 controls the immobilizer 42 to unlock engine start in response to the unlock signal from the debt collection server 1. For example, the ECU 41 resets the flag such that the immobilizer 42 reacts when the engine start button of the input unit 48 is pressed, thereby to unlock engine start. Thereby, in the case of an instruction of engine start via the input unit 48, the ECU 41 can drive the engine of the vehicle 4. Consequently, the user, such as the debtor, confirms at least one of the reminder message and the advertisement displayed on the display apparatus 44, and afterward can use the vehicle 4.

Subsequently, the control unit 11 determines whether or not the second signal indicating that the debt of the vehicle 4 is performed is received from the credit management server 2, for example (step S507). When it is determined by the control unit 11 that the second signal is received from the credit management server 2 (step S507: Yes), the debt collection server 1 ends the present processing. On the other hand, when it is determined by the control unit 11 that the second signal is not received from the credit management server 2 (step S507: No), the debt collection server 1 moves to step S508.

Subsequently, the control unit 11 determines whether or not a predetermined time has elapsed after reproduction of at least one of the reminder message and the advertisement is performed and finished on the display apparatus 44 (step S508). When the control unit 11 determines that the predetermined time has elapsed (step S508: Yes), the vehicle 4 moves to step S509. On the other hand, when the ECU 41 determines that the predetermined time has not elapsed (step S508: No), the vehicle 4 returns to step S507.

Subsequently, the ECU 41 transmits at least one of the reminder message corresponding to the reminder information and the advertisement regarding the advertisement information (step S509). In this case, the vehicle 4 displays at least one of the reminder message corresponding to the reminder information and the advertisement regarding the advertisement information transmitted from the debt collection server 1 on the display apparatus 44.

Subsequently, when the second signal is received from the vehicle information server 3 (step S510: Yes), the debt collection server 1 ends the present processing. On the other hand, when the second signal is not received from the vehicle information server 3 (step S510: No), the vehicle information server 3 returns to step S508.

According to Embodiment 2 described above, as with Embodiment 1, when the first signal is received from the credit management server 2, the control unit 11 outputs at least one of a display on the display apparatus 44 of the vehicle 4 or a voice on the voice output unit 46 by remote control, the display or the voice being relevant to at least one of the reminder regarding performance of the credit or the advertisement corresponding to performance of the debt, and hence, the debtor can understand that payment of the debt regarding the vehicle 4 is not correctly performed.

### Other Embodiments

Further effects and modifications can be readily derived by a person skilled in the art. Therefore, wider aspects of the present disclosure are not limited to the specific details and the representative embodiments presented and described as above. Accordingly, various alterations are possible without departing from the overall concept and scope of the disclosure defined by the appended claims and their equivalents.

For example, while Embodiments 1 and 2 have been described while supposing the debt collection server 1 or the vehicle 4, the credit management server 2 or the vehicle information server 3 itself may have the functions of the control unit 11 or the ECU 41. In this case, the credit management server 2 or the vehicle information server 3 may have the functions of the control unit 11 and the vehicle history DB 12 of the debt collection server 1. Moreover, the vehicle control apparatus according to Embodiment 1, 2 may cause the vehicle 4 to take one or some of the processes of the debt collection server 1 and/or the vehicle information server 3.

Moreover, while in the embodiments of the present disclosure, the debt collection server 1, the credit management server 2, and the vehicle information server 3 have been described as respective separate apparatuses, the debt collection server 1, the credit management server 2, and the vehicle information server 3 may be constituted of one, two, four or more apparatuses.

What is claimed is:

1. A vehicle control apparatus, comprising a processor, wherein the processor is configured to:
perform, when a first signal indicating that completion of an unresolved condition regarding a target vehicle is not correctly performed is received from a account condition monitoring server configured to manage account condition of the target vehicle, control to lock engine start of the target vehicle in response to reception of the first signal;
acquire at least one of an alert for prompting execution of the account condition or a publicity content for advancing execution of the account condition from a memory;
reproduce and display at least one of an alert message corresponding to the alert and a visual content corresponding to the publicity content on a display apparatus included in the target vehicle; and
perform, after reproduction of the alert message or the visual content is finished, control to unlock engine start of the target vehicle.

2. A vehicle control apparatus, comprising a processor, wherein the processor is configured to:
perform, when a first signal indicating that payment of a debt regarding a target vehicle is not correctly performed is received from a credit management server configured to manage credit of the target vehicle, control to lock engine start of the target vehicle in response to reception of the first signal;
acquire at least one of a reminder of encouraging payment regarding performance of the credit or an advertisement of encouraging payment regarding performance of the credit from a memory;
reproduce and display at least one of a reminder message corresponding to the reminder and a video image corresponding to the advertisement on a display apparatus included in the target vehicle; and
perform, after reproduction of the reminder message or the video image is finished, control to unlock engine start of the target vehicle.

3. A vehicle control apparatus, comprising a processor, wherein the processor is configured to output, when a first signal indicating that payment of a debt regarding a target vehicle is not correctly performed is received, at least one of a reminder and an advertisement of encouraging payment regarding performance of the debt in response to reception of the first signal.

4. The vehicle control apparatus according to claim 3, wherein the outputting at least one of the reminder and the advertisement includes outputting at least one of a display and a voice regarding the at least one of the reminder and the advertisement.

5. The vehicle control apparatus according to claim 4, wherein:
the outputting the reminder includes outputting a video image of encouraging payment regarding performance of the debt; and
the processor is configured to:
perform control to lock engine start of the target vehicle in response to reception of the first signal; and
perform control to unlock engine start of the target vehicle after the video image is output for a predetermined time.

6. The vehicle control apparatus according to claim 4, wherein:
the outputting the advertisement includes outputting a video image regarding a predetermined advertisement; and
the processor is configured to:
perform control to lock engine start of the target vehicle in response to reception of the first signal; and
perform control to unlock engine start of the target vehicle after the video image is output for a predetermined time.

7. The vehicle control apparatus according to claim 5, wherein the processor is configured to:
determine whether or not a second signal indicating that the debt is performed is received from a credit management server; and
output, when the second signal is determined to be not received, at least one of the reminder and the advertisement periodically or not periodically until the second signal is received.

8. The vehicle control apparatus according to claim 4, wherein the outputting at least one of the reminder and the advertisement includes outputting at least one of the reminder and the advertisement to at least one of an interior monitor and an exterior monitor included in the target vehicle.

9. The vehicle control apparatus according to claim 8, wherein the outputting at least one of the reminder and the advertisement to the exterior monitor includes outputting a content indicating that the debt is not correctly performed.

10. The vehicle control apparatus according to claim 4, wherein the outputting the reminder includes outputting information having a video image superimposed, the
information indicating that the debt is not correctly performed, the video image being displayed on a terminal apparatus on a side of a person on a video call or a video conference when the video call or the video conference is performed via a communication unit included in the target vehicle.

11. The vehicle control apparatus according to claim 4, wherein the outputting the reminder includes providing guidance of a facility for performing the debt or providing guidance of a path passing through the facility, via a car navigation system included in the target vehicle.

12. The vehicle control apparatus according to claim 3, wherein the processor is configured to:
output, when the first signal is received, a lock signal for locking engine start of the target vehicle by remote control to an immobilizer included in the target vehicle to perform remote lock control;
acquire at least one of a reminder of encouraging payment regarding performance of the debt or an advertisement of encouraging payment regarding performance of the debt from a memory;
output at least one of a reminder message corresponding to the reminder and a video image corresponding to the advertisement to a display apparatus included in the target vehicle to display at least one of the reminder message and the video image by remote control; and
output, after reproduction of the reminder message or the video image is finished, an unlock signal for unlocking engine start of the target vehicle by remote control to the immobilizer to perform remote unlock control.
